(19) United States
(12) Patent Application Publication
(10) Pub. No.: US 2010/0293398 A1
(43) Pub. Date: Nov. 18, 2010

(54) System and Method for Preventing Disconnect of a Powered Device by a Power Source Equipment

(75) Inventor: Wael William Diab, San Francisco, CA (US)

Correspondence Address: LAW OFFICE OF DUANE S. KOBAYASHI, P.O. Box 4160, Leesburg, VA, 20177, US

(73) Assignee: Broadcom Corporation, Irvine, CA (US)

(21) Appl. No.: 12/843,379

(22) Filed: Jul. 26, 2010

Related U.S. Application Data
(62) Division of application No. 11/697,438, filed on Apr. 6, 2007.

(51) Int. Cl. G06F 1/26; H02J 7/34

(52) U.S. Cl. 713/300; 307/48

(57) ABSTRACT

A system and method for preventing disconnect of a powered device by a power source equipment. Powered devices can have unstable power profiles. These unstable power profile can make it difficult for power source equipment (PSE) in a power over Ethernet (PoE) system to effectively manage powering of those devices. In one embodiment, a reservoir of charge having a stable power profile is provided as a charge buffer such that a PSE need not match the swings in power demands by electronic circuitry in the powered device.

This application is a divisional of non-provisional patent application Ser. No. 11/697,438, filed Apr. 6, 2007, which is incorporated herein by reference in its entirety.

### BACKGROUND

1. Field of the Invention

The present invention relates generally to Power over Ethernet (PoE) and, more particularly, to a system and method for preventing disconnect of a powered device by a power source equipment.

2. Introduction

The IEEE 802.3af and 802.3at PoE specifications provide a framework for delivery of power from power source equipment (PSE) to a powered device (PD) over Ethernet cabling. In this PoE process, a valid device detection is first performed. This detection process identifies whether or not it is connected to a valid device to ensure that power is not applied to non-PoE capable devices. After a valid PD is discovered, the PSE can optionally perform a power classification. The completion of this power classification process enables the PSE to manage the power that is delivered to the various PDs connected to the PSE.

Managing PDs such as VoIP phones, wireless LAN access points, Bluetooth access points, and network cameras is one of the tasks of the PSE. In general, a PSE is designed to provide stable output power to a PD. The relative difficulty of this task is dependent on the behavior of the PD. For example, if the PD maintains a level power draw, then the PSE's task is relatively simply. If, on the other hand, the PD is susceptible to rapid power changes, then the dI/dt and dV/dt profiles are very difficult for the PSE controller to handle. An inability to handle such rapid power draw changes can then lead to a PSE's inability to support a class of network devices. What is needed therefore is mechanism for powering PDs having unstable and/or rapidly changing power profiles.

### SUMMARY

A system and/or method for preventing disconnect of a powered device by a power source equipment, substantially as shown in and/or described in connection with at least one of the figures, as set forth more completely in the claims.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an embodiment of a PoE system.

FIG. 2 illustrates a simplified view of a PoE system.

FIG. 3 illustrates an embodiment of an application of PoE to portable computing devices.

FIG. 4 illustrates another embodiment of an application of PoE to portable computing devices.

FIG. 5 illustrates a flowchart of a process for powering a portable computing device using PoE.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

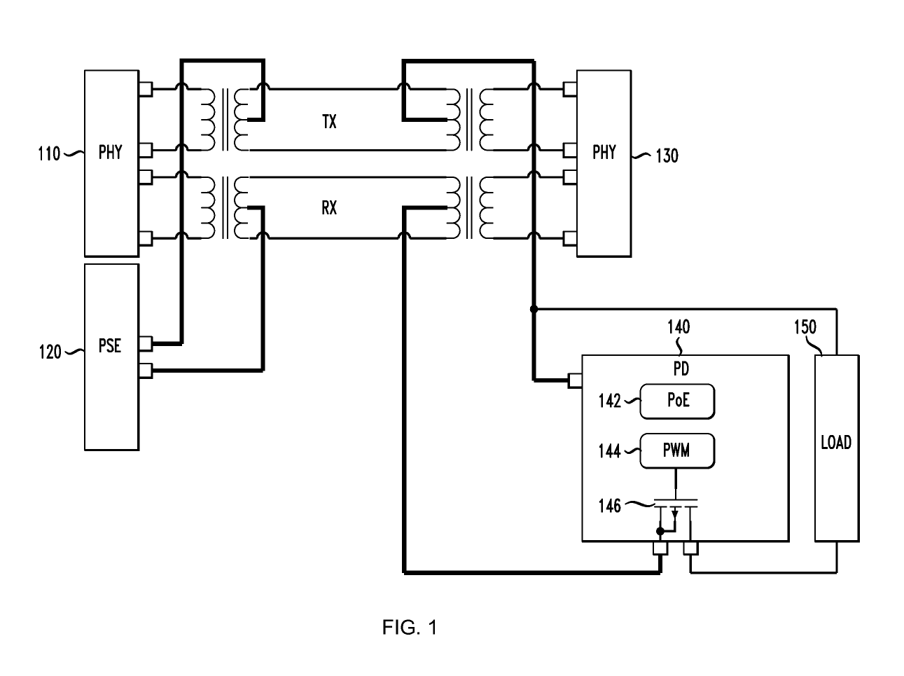

FIG. 1 illustrates an embodiment of a power over Ethernet (PoE) system. As illustrated, the PoE system includes power source equipment (PSE) 120 that transmits power to powered device (PD) 140. Power delivered by the PSE to the PD is provided through the application of a voltage across the center taps of transformers that are coupled to a transmit (TX) pair and a receive (RX) pair of wires carried within an Ethernet cable. The two TX and RX pairs enable data communication between Ethernet PHYs 110 and 130.

As is further illustrated in FIG. 1, PD 140 includes PoE module 142. PoE module 142 includes the electronics that would enable PD 140 to communicate with PSE 120 in accordance with a PoE standard such as IEEE 802.3af, 802.3at, etc. PD 140 also includes pulse width modulation (PWM) DC:DC controller 144 that controls power FET 146, which in turn provides constant power to load 150.

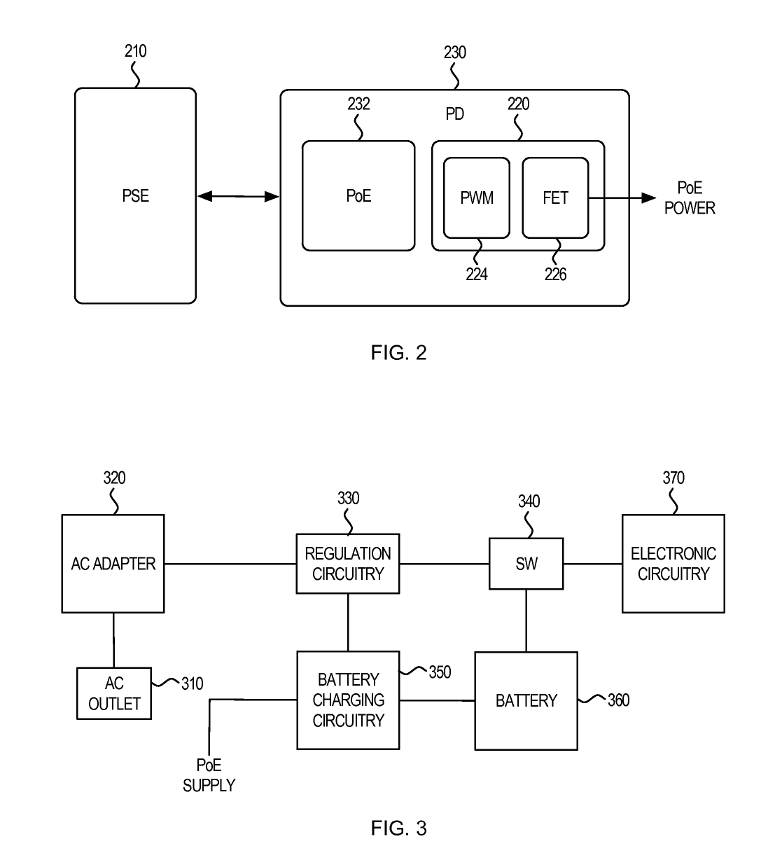

FIG. 2 illustrates a simplified view of a PoE system. In this illustration, PSE 210 is shown delivering power to PD 230. In the IEEE 802.3af standard, PSE 210 can deliver up to 15.4 W of power to a plurality of PDs (only one PD is shown in FIG. 2 for simplicity). In the IEEE 802.at specification, a PSE can deliver up to 30 W of power to a PD over 2-pairs or 60 W of power to a PD over 4-pairs. Other proprietary solutions can potentially deliver even higher levels of power to a PD. In general, high power solutions are often limited by the limitations of the cabling.

As further illustrated in FIG. 2, PD 230 includes PoE module 232. This module includes the electronics that would enable PD 230 to communicate with PSE 210 in accordance with the a PoE specification such as IEEE 802.3af, 802.3at, etc. PD 230 also includes power module 220, which further includes a PWM controller 224 and power FET 226. Power FET 226 is designed to produce output PoE power based on the power provided by PSE 210 over network cabling. In various embodiments, PWM controller 224 and power FET 226 can be incorporated in a single die, or can be on separate dies as part of a multi-chip module.

As will become apparent in the following description, the principles of the present invention are not dependent on certain design choices of the power module. For example, power module 220 can be designed to include other types of controllers or power transistors.

As noted, one of the responsibilities of PSE 210 is to manage the power that is supplied to PD 230. If PD 230 is a relatively stable and/or predictable device (or operates within defined specifications) such as a wireless LAN access point, then the dI/dt and dV/dt profiles can be handled by PSE 210. Not every PD, however, exhibits such controlled levels of power draw. For example, consider a portable computing device such as a portable computer. This portable computer can exhibit rapid changes in the power required to support its internal components. As would be appreciated, these internal components need not be uniform and can vary greatly between devices depending on the manufacturer and component suppliers. Moreover, power usage can be highly dependent on the application(s) running on the portable computer. In one operating state, the portable computer can be in relatively idle state or performing simple tasks such as word processing. In another operating state, the portable computer can be performing a variety of simultaneous tasks such as video encoding, disc burning, game playing, and even powering other USB devices. As would be appreciated, transitions between operating states such as those exemplified above, can be rapid and continual as the usage requirements of the portable computer change in accordance with the directives of the portable computer user. In general, these changes in operating state can be large and unpredictable, thereby resulting in an unstable power profile. Notwithstanding these unstable power profiles, there is significant value in being able to power portable computing devices via the network.

Portable computing devices that are connected to enterprise networks are typically connected on a non-permanent basis. Consider, for example, a corporate conference room that has multiple Ethernet ports for conference participants. Here, conference participants will be connected to the Ethernet port for the duration of the conference. If the conference extends for multiple hours, most conference participants would need to power their portable computing device using an external AC adapter due to battery charges that have been depleted. Usage of these external AC adapters is inconvenient and cumbersome, and would be obviated if the portable computing device could be powered via the network.

It is a feature of the present invention, that powering portable computing devices having unstable power profiles via a network can be accomplished by powering electronic circuitry in the portable computing device indirectly. As illustrated in FIG. 2, power FET 226 is used to generate PoE output power. Depending on the nature of the internal electronics within the PD, power conversion circuitry would also be used to perform rail conversions to deliver power to any number of loads that are designed to operate at a given voltage such as 5.0 V, 3.3 V, 2.5 V, 1.8 V, 1.5 V, etc.

The various loads can represent system components such as a motherboard, LCD screen, hard disk drive, optical drive, etc. As would be appreciated, the various loads within the portable computing device can be individually activated based on user-directed system usage. If these loads were driven directly by one or more power FETs 226, then PSE 210 would need to account for the unstable power profile of PD 230. By way of example, these “bad power profiles” have various disadvantages such as the following: (1) cause the PSE to disconnect the PD if the dV/dt or dI/dt goes out of the supported range; (2) impact data integrity (i.e., data transmission can start to see errors) because the transformers may not be “fully symmetric” meaning that there is DC-Resistance (DCR) and Inductance imbalance, such that transients will affect the data integrity; (3) due to the existence of two types of environments in IEEE (Environment A only requires port-to-ground isolation, while Environment B requires port-to-port isolation), many manufacturers can design a PSE for Environment A such that noise by one PD can make it through to the switch system power supply, other ports, or other places in the system; (4) the surge/transient can cause other ports to shut down (for example adjacent ports under environment A); (5) in addition to imbalance in the transformer, there is also imbalance in the cabling which will amplify the effect above; and (6) transients may cause the switch/device to no longer comply with safety and/or immunity specs such as EMI.

In accordance with the present invention, the electronic circuitry of portable computing device is powered indirectly through the powering of a portable computing device component having a stable power profile. In general, this portable computing device component can represent a reservoir of power that provides a buffer between the PSE and the electronic circuitry of the portable computing device. This reservoir of power can act as a capacitive element that acts as a reservoir and dampens the transients downstream from it. In one embodiment, this reservoir of power is a rechargeable battery within the portable computing device. By powering the reservoir of power instead of the electronic circuitry, the PSE does not need to account for wide fluctuations in power draw based on changes in use.

FIG. 3 illustrates an embodiment of a mechanism by which a PSE can charge a rechargeable battery in a portable computing device. As illustrated in FIG. 3, AC adapter 320 is designed to convert AC power from AC outlet 310 to DC power that can power electronic circuitry 370 in the portable computing device. As noted above, electronic circuitry 370 can also include power conversion circuitry that would perform rail conversions to deliver power to any number of loads that are designed to operate at a given voltage such as 5.0 V, 3.3 V, 2.5 V, 1.8 V, 1.5 V, etc.

The DC power that is generated by AC adapter 320 is delivered to regulation circuitry 330, which can be designed to monitor and control the current drawn from AC adapter 320. Regulation circuitry 330 then provides power to two different paths, one path destined for electronic circuitry 370 and one path destined to rechargeable battery 360. Included in the latter path is battery charging circuitry 350, which can be designed to monitor the current used to charge rechargeable battery 360. Battery charging circuitry 350 can also be designed to cut off the provision of charging current to rechargeable battery 360 once it is determined that rechargeable battery 360 is fully charged. As further illustrated in FIG. 3, there is also a loopback from rechargeable battery 360 to switch 340. Switch 340 is generally operative to power electronic circuitry 370 using power from either AC adapter 320 or from rechargeable battery 360.

In powering the portable computing device using PoE, power can be delivered directly to electronic circuitry 370. As noted above, a disadvantage of this solution is that it would require the PSE to manage dI/dt and dV/dt behavior that may operate outside supported ranges. A further disadvantage is the possibility of having to repeat all of the 5.0 V, 3.3 V, 2.5 V, 1.8 V, 1.5 V, etc. power rails separately. This solution would introduce undesired complexity along with the added expense.

It is therefore a feature of the present invention that PoE power is tapped into battery charging circuitry 350. In this manner, the PoE power supply would not need to account for wide fluctuations by the operation of the portable computing device. Instead, the PoE power supply would provide power solely to rechargeable battery 360, whose power profile is much better known and controllable.

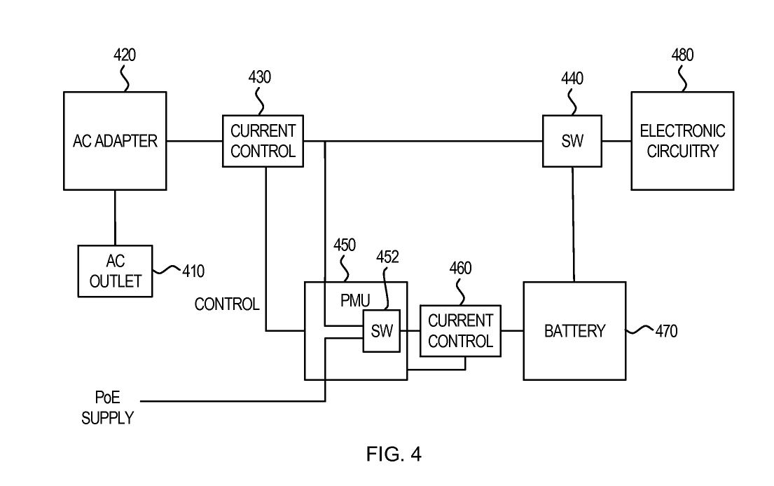

FIG. 4 illustrates another embodiment of a mechanism by which a PSE can charge a rechargeable battery in a portable computing device. As illustrated in FIG. 4, AC adapter 420 is designed to convert AC power from a AC outlet 420. Delivery of power to both electronic circuitry 480 and rechargeable battery 470 is under control of power management unit (PMU) 450. While the specific functions of PMU 450 are dependent on the specific design of the battery charging circuit, PMU 450 can be generally responsible for controlling the relative delivery of power to both electronic circuitry 480 and rechargeable battery 470. For example, PMU 450 can be designed to maximize the amount of power delivered to rechargeable battery 470 by monitoring the current drawn from AC adapter 420.

This monitoring can be effected through current control module 430, which monitors and controls the total current used to power electronic circuitry 480 and rechargeable battery 470. In one embodiment, PMU 450 can also monitor the current used to charge rechargeable battery 470 using current control module 460. For example, as the current requirements of electronic circuitry 480 increases, current control module 460, under the control of PMU 450, can begin to adjust the battery charging current downward. As FIG. 4 further illustrates, PMU 450 also includes a switching component 452 that is designed to control the provision of charging current to rechargeable battery 470. This enables PMU 450 to cut off the provision of charging current to rechargeable battery 470 if rechargeable battery 470 is fully charged.

As noted, a PSE does not power electronic circuitry 480 directly. Rather, the PSE is designed to provide power to rechargeable battery 470. In this framework, the PSE provides power to a device having stable power requirements, while indirectly providing power to electronic circuitry 480.

As in the previous embodiment, a PoE power output generated by a PD is added to the battery charge circuitry already present in the portable computing device. In the battery charging circuitry example of FIG. 4, a PoE power supply based on the PoE power output is routed to switch 452 in PMU 450. Switch 452, under control of PMU 450, can then routed power to rechargeable battery 470. Significantly, this PoE power supply is not used to power electronic circuitry 480 directly.

It should be noted that the embodiments described above would not allow the portable computing device to run solely on PoE when a rechargeable battery is not installed. This consequence is not significant, however, because most portable computing devices are not dedicated network devices. Rather, most portable computing devices are primarily run off of a rechargeable battery that enables the portable nature of the device.

It should also be noted that the example embodiments provides example implementations of using PoE to charge a rechargeable battery in a portable computing device. As various implementations of battery charging circuits exist in the field of portable computing devices, the specific mechanism by which a PoE power output can be integrated into a battery charging circuit would be implementation dependent. The illustrated embodiments should therefore not be construed as limiting the scope of the present invention.

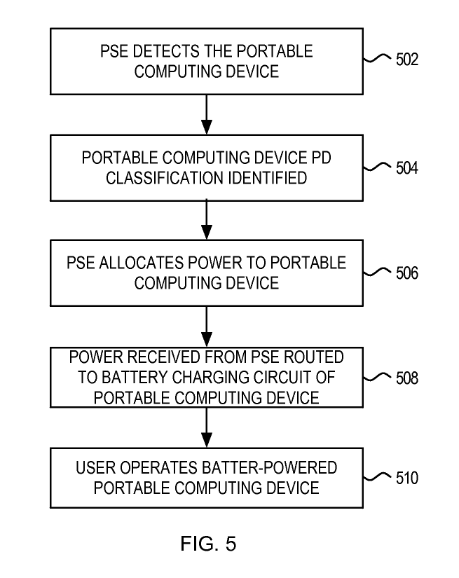

FIG. 5 illustrates a flowchart of a process of providing PoE power to a portable computing device. As illustrated, the flowchart of FIG. 5 begins at step 502 where the PSE detects the portable computing device. In one embodiment, this detection process is enabled using a 25 kΩ resistor, which is applied as a load across the line. The portable computing device is detected by the PSE once the PSE detects the proper signature impedance.

After the PSE detects the portable computing device, the PSE, at step 504, then identifies the PD classification of the portable computing device. In one embodiment, the PSE measures the current drawn when the voltage output by the PSE is between the 15.5 V-20.5 V range. The response measured by the PSE is used to classify the PD, for example, in accordance with the five PD classes specified by the 802.3af standard. Based on this determined classification, the PSE, at step 506, then allocates power to the portable computing device. As would be appreciated, the particular classification scheme can vary and could also include classification schemes based on Layer 2 such as LLDP and those being defined in 802.1AB, and 802.3at.

At step 508, power that is received from the PSE is routed to a battery charging circuit of the portable computing device. As noted, this power is used to charge a rechargeable battery. Power from the rechargeable battery is then used to operate the portable computing device.

Depending on the PD classification or other constraints, the PoE power used to charge the rechargeable battery may or may not be sufficient to match the actual power being drawn by the electronic circuitry of the portable computing device at a given point in time. As such, in actual use, there may be times when the rate of power usage by the electronic circuitry may exceed the rate of charging of the rechargeable battery. In these instances, the overall charge stored by the rechargeable battery may decrease for a period of time. When the rate of power usage by the electronic circuitry falls below the rate of charging of the rechargeable battery, then the overall charge stored by the rechargeable battery would increase for a period of time.

In general, the fluctuations in the relative amounts of power being consumed/added to the rechargeable battery can be tolerated by the initial charge of the rechargeable battery. If the rechargeable battery has substantial charge when the portable computing device is connected to the Ethernet cable, then significant periods of power deficiency can be tolerated. Regardless, the amount of charge added to the battery by PoE represents additional usage capacity that is provided to the portable computing device without the need for an external AC adapter.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. Also, it is to be understood that the phraseology and terminology employed herein are for the purposes of description and should not be regarded as limiting.

What is claimed is:

1. A method for preventing a remote power source equipment from disconnecting a powered device having a rapidly changing power profile, said powered device being coupled to said remote power source equipment using a network communication cable, comprising:
receiving, at said powered device, power from said remote power source equipment via said network communication cable;
routing said received power to a charge buffer in said powered device, said charge buffer being designed to present a stable power profile to said remote power source equipment, wherein said charge buffer dampens dI/dt and/or dV/dt transients produced in response to rapid swings in power demands by one or more loads in said powered device; and
powering one or more loads in said powered device using power that has passed through said charge buffer.

2. The method of claim 1, wherein said powered device is a portable powered device.

3. The method of claim 2, wherein said powered device is a portable computing device.

4. The method of claim 1, wherein said charge buffer removes a need of said power sourcing equipment to match said rapid swings in power demands.

5. The method of claim 1, wherein said charge buffer is a capacitive element.

8. The method of claim 1, wherein said receiving comprises receiving power via one of the IEEE 802.3af and 802.3at specifications.

9. The method of claim 1, wherein said powering comprises powering at a rate that matches a power drawn by said one or more loads.

10. A method in a network for managing a powering of a device having a rapidly changing power profile, comprising:
providing a charge buffer in a powered device that is sufficient to match rapid swings in power demands by one or more loads in a powered device, said charge buffer being coupled to said one or more loads in said powered device;
dampening, using said provided charge buffer, dI/dt and/or dV/dt transients produced in response to said rapid swings in power demands by said one or more loads; and
powering said one or more loads in said powered device by passing power through said charge buffer, said power being provided to said charge buffer via an Ethernet cable that couples a power sourcing equipment to said powered device.

11. The method of claim 10, wherein said powered device is a portable powered device.

12. The method of claim 11, wherein said powered device is a portable computing device.

13. The method of claim 10, wherein said charge buffer removes a need of said power sourcing equipment to match said rapid swings in power demands.

14. The method of claim 10, wherein said charge buffer is a capacitive element.

15. The method of claim 10, wherein said dampening comprises maintaining a stable power draw as seen by said power sourcing equipment.

16. The method of claim 10, wherein said dampening comprises dampening transients produced by changes in operating states of said powered device.

17. The method of claim 10, wherein said powering comprises powering via one of the IEEE 802.3af and 802.3at specifications.

18. The method of claim 10, wherein said powering comprises powering at a rate that matches a power drawn by said one or more loads.
